(19) United States
(12) Patent Application Publication
(10) Pub. No.: US 2025/0319903 A1
(43) Pub. Date: Oct. 16, 2025

(54) Method and System for Evaluating Accuracy of Target Trajectory Prediction Based on Trajectory Information of Target

(71) Applicants: Hyundai Motor Company, Seoul (KR); Kia Corporation, Seoul (KR)

(72) Inventor: Sung Wook Lee, Seoul (KR)

(21) Appl. No.: 18/967,912

(22) Filed: Dec. 4, 2024

(30) Foreign Application Priority Data
Apr. 12, 2024 (KR) 10-2024-0049607

(51) Int. Cl. B60W 60/00; B60W 50/02; G06N 3/0455

(52) U.S. Cl. CPC B60W 60/0027; B60W 50/02; G06N 3/0455

(57) ABSTRACT

An apparatus for controlling autonomous driving of a vehicle is introduced. The apparatus may comprise a processor and a memory configured to store one or more instructions, when executed by the processor, configured to cause the apparatus to store trajectory history data of a target object, generate, based on the trajectory history data, a trajectory history matrix for a time window of a sampling, input the trajectory history matrix into a machine learning model to determine reconstruction loss, wherein the machine learning model may comprise an autoencoder trained based on previous trajectory history data associated with movement of at least one object, determine, based on the reconstruction loss, a trajectory prediction accuracy, generate a signal indicating the trajectory prediction accuracy, and control, based on the signal, the autonomous driving of the vehicle.

### CROSS-REFERENCE TO RELATED APPLICATION

This application claims priority to Korean Patent Application No. 10-2024-0049607, filed on Apr. 12, 2024 in the Korea Intellectual Property Office, the entire contents of which are incorporated herein by reference.

### TECHNICAL FIELD

The present disclosure relates to a method and system for evaluating accuracy of target trajectory prediction based on trajectory information of a target, and more particularly, to a method and system for determining whether a predicted trajectory of a target is accurate based on time-series data representing a trajectory of the target and an autoencoder model.

### BACKGROUND

The matters described in this Background section are only for enhancement of understanding of the background of the disclosure, and should not be taken as acknowledgement that they correspond to prior art already known to those skilled in the art. An autonomous vehicle may predict a future trajectory of objects (targets) around the autonomous vehicle for trajectory planning and collision avoidance control. For example, if there are objects, such as other vehicles, pedestrians, or personal mobility devices, around the autonomous vehicle, the autonomous vehicle may predict a future trajectory of an object and generate a driving trajectory that does not collide with the object. If the autonomous vehicle erroneously predicts the future trajectory of the object, an accident may occur where the autonomous vehicle collides with the object. Therefore, when the autonomous vehicle predicts a future trajectory of the object, an autonomous driving system may be able to accurately determine whether the predicted trajectory is trustworthy.

Trajectory information of a target, such as a current speed, heading angle, and lane information of the target, may be obtained from a sensor of an autonomous vehicle, and a future trajectory of the target may be predicted on the assumption that trajectory information of the target is maintained until a certain time point in the future. Therefore, in an autonomous driving system, it may be determined that, if a target recognition confidence level of the sensor is high, predicted trajectory of the target calculated using trajectory information of the target obtained from the sensor is valid. In other words, the autonomous driving system may evaluate the accuracy of trajectory prediction of the target using a confidence level of the information obtained from the sensor.

Such autonomous driving system may have the problem of determining the accuracy of trajectory prediction using only trajectory information of the target at the current time point without considering future uncertainty of the target. For example, if the target is a vehicle and a driver of the vehicle drives recklessly, there is a high possibility that the target will drive on an unexpected trajectory in the future. When the target is a pedestrian, if a distribution of a movement direction and speed of the pedestrian measured for a certain period of time is large, the movement trajectory predicted by the autonomous driving system is also likely to be inaccurate.

### SUMMARY

According to the present disclosure, an apparatus for controlling autonomous driving of a vehicle, the apparatus may comprise a processor and a memory configured to store one or more instructions, when executed by the processor, configured to cause the apparatus to store trajectory history data of a target object, generate, based on the trajectory history data, a trajectory history matrix for a time window of a sampling, input the trajectory history matrix into a machine learning model to determine reconstruction loss, wherein the machine learning model may comprise an autoencoder trained based on previous trajectory history data associated with movement of at least one object, determine, based on the reconstruction loss, a trajectory prediction accuracy, generate a signal indicating the trajectory prediction accuracy, and control, based on the signal, the autonomous driving of the vehicle.

The apparatus, wherein the one or more instructions, when executed by the processor, further configured to cause the apparatus to determine a rank of the trajectory history matrix, wherein the determination of the trajectory prediction accuracy is further based on the rank of the trajectory history matrix, and wherein the rank of the trajectory history matrix represent a number of unique trajectories without redundancy the trajectory history matrix can define.

The apparatus, wherein the rank of the trajectory history matrix corresponds to a number of linearly independent columns in the trajectory history matrix.

The apparatus, wherein the determination of the trajectory prediction accuracy is further based on a target recognition confidence level of a sensor.

The apparatus, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

The apparatus, wherein the one or more instructions, when executed by the processor, are further configured to cause the apparatus to set, based on a driving environment of the vehicle, the time window of a sampling to a different time window.

The apparatus, wherein the one or more instructions, when executed by the processor, are further configured to cause the apparatus to set the time window of a sampling to be longer for a highway driving than a downtown driving.

According to the present disclosure, a method performed by an apparatus for controlling autonomous driving of a vehicle, the method may comprise storing trajectory history data of a target object, generating, based on the trajectory history data, a trajectory history matrix for a time window of a sampling, inputting the trajectory history matrix into a machine learning model to determine reconstruction loss, wherein the machine learning model may comprise an autoencoder trained based on previous trajectory history data associated with movement of at least one object, determining, based on the reconstruction loss, a trajectory prediction accuracy, generating a signal indicating the trajectory prediction accuracy, and controlling, based on the signal, the autonomous driving of the vehicle.

The method may further comprise determining a rank of the trajectory history matrix, wherein the determining the trajectory prediction accuracy is further based on the rank of the trajectory history matrix, and wherein the rank of the trajectory history matrix represent a number of unique trajectories without redundancy the trajectory history matrix can define.

The method, wherein the rank of the trajectory history matrix corresponds to a number of linearly independent columns in the trajectory history matrix.

The method, wherein the determining the trajectory prediction accuracy is further based on a target recognition confidence level of a sensor.

The method, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

The method may further comprise setting, based on a driving environment of the vehicle, the time window of a sampling to a different time window.

The method may further comprise setting the time window of a sampling to be longer for a highway driving than a downtown driving.

According to the present disclosure, a non-transitory computer-readable medium storing instructions, when executed, cause an apparatus to store trajectory history data of a target object, generate, based on the trajectory history data, a trajectory history matrix for a time window of a sampling, input the trajectory history matrix into a machine learning model to determine reconstruction loss, wherein the machine learning model may comprise an autoencoder trained based on previous trajectory history data associated with movement of at least one object, determine, based on the reconstruction loss, a trajectory prediction accuracy, generate a signal indicating the trajectory prediction accuracy, and control, based on the signal, autonomous driving of a vehicle.

The non-transitory computer-readable medium, wherein the instructions, when executed, are further configured to cause the apparatus to determine a rank of the trajectory history matrix, wherein the determination of the trajectory prediction accuracy is further based on the rank of the trajectory history matrix, and wherein the rank of the trajectory history matrix represent a number of unique trajectories without redundancy the trajectory history matrix can define.

The non-transitory computer-readable medium, wherein the rank of the trajectory history matrix corresponds to a number of linearly independent columns in the trajectory history matrix.

The non-transitory computer-readable medium, wherein the determination of the trajectory prediction accuracy is further based on a target recognition confidence level of a sensor.

The non-transitory computer-readable medium, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

The non-transitory computer-readable medium, wherein the instructions, when executed, are further configured to cause the apparatus to set, based on a driving environment of the vehicle, the time window of a sampling to a different time window.

### BRIEF DESCRIPTION OF THE DRAWINGS

FIG. 1 shows an example of an apparatus for evaluating accuracy of trajectory prediction of a target according to an example of the present disclosure.

FIG. 2 shows an example of a trajectory history matrix generated by a processor according to an example of the present disclosure.

FIG. 3 shows an example of a method for determining accuracy of trajectory prediction of a target according to an example of the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe examples of the present disclosure, and is not intended to represent the only examples in which the present disclosure may be practiced.

A device for evaluating accuracy of trajectory prediction according to an example of the present disclosure receives trajectory history data of a target from a vehicle sensor and outputs accuracy of trajectory projection. In the present disclosure, trajectory prediction refers to predicting, by an autonomous driving system, a future trajectory of an object (i.e., a target) around an autonomous vehicle based on trajectory information of the object. In the present disclosure, accuracy of trajectory prediction refers to a level of confidence of a predicted future trajectory.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., reconstruction loss) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., reconstruction loss) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., reconstruction loss) described herein.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., reconstruction loss) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

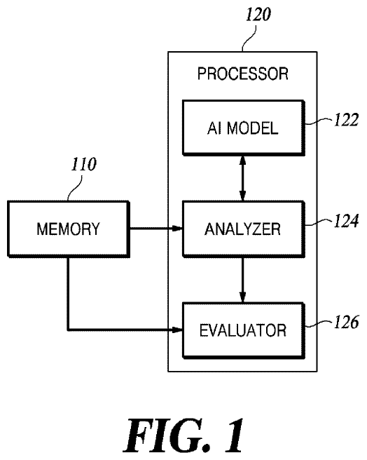

FIG. 1 shows an example of a device for evaluating accuracy of trajectory prediction according to an example of the present disclosure.

The device for evaluating accuracy may be implemented in the form of, for example, an embedded device, a server, etc. The device for evaluating accuracy may include a memory 110 and a processor 120. The processor 120 may include an artificial intelligence (AI) model 122, an analyzer 124, and an evaluator 126. Not all blocks shown in FIG. 1 are essential components, and in other examples, some blocks included in the device for evaluating accuracy may be added, changed, or deleted. Meanwhile, the components shown in FIG. 1 represent functionally distinct elements, and at least one component may be implemented in an integrated form in an actual physical environment.

The accuracy evaluation device receives trajectory history data and a target recognition confidence level of the sensor from the sensor and stores the same in the memory 110. For example, the accuracy evaluation device may be electrically connected to the sensor to receive the trajectory history data and the target recognition confidence level and store the same in the memory 110.

In the present disclosure, the trajectory history data is used as data related to the trajectory of a target. Trajectory history data includes trajectory information of the target measured by the sensor at regular time intervals (sampling time). The trajectory information of the target may include a longitudinal relative distance, a lateral relative distance, a longitudinal relative speed, a lateral relative speed, a longitudinal relative acceleration, a lateral relative acceleration between a subject vehicle and the target, a heading angle of the target, a lateral relative distance between the target and a lane, etc.

The memory 110 may store data and instructions necessary for operation of the accuracy evaluation device. The memory 110 may be implemented as at least one of a volatile storage medium or a non-volatile storage medium, or a combination thereof. The memory 110 may be implemented as various types of storage mediums. The memory 110 may include at least one type of storage medium, among a flash memory type, a hard disk type, a multimedia card micro type, a card type memory (e.g., SD or XD memory, etc.), or random access memory (RAM), static RAM (SRAM), read-only memory (ROM), electrically erasable programmable read-only memory (EEPROM), programmable read-only memory (PROM), magnetic memory, magnetic disk, and optical disk. According to an example, the memory 110 may correspond to a cloud storage space. For example, the network monitoring device 100 and memory 110 may be implemented through a cloud service.

The processor 120 controls the overall operation of the accuracy evaluation device. The processor 120 may be implemented with one or more processors. The processor 120 may perform a predetermined operation by executing instructions stored in the memory.

The processor 120 performs an operation of the pre-trained AI model 122. The AI model 122 may be implemented as a predetermined software block or hardware block. For example, the processor 120 may execute a computer program stored in the memory 110 to perform the operation of the AI model 122. According to another example, the processor 120 may include a dedicated processor that performs an operation of a machine learning model, and the operation of the AI model 122 may be performed by the dedicated processor. According to another example, the processor 120 may use the AI model 122 that operates in an external device, such as a server. In this case, the processor 120 may transmit trajectory history data to the AI model 122 of the external device and receive an output of the AI model 122 from the external device.

The AI model 122 includes a pre-trained autoencoder. The autoencoder reconstructs input data to generate output data. If normal input data is input, the autoencoder generates reconstructed output data that is identical to or similar to the input data. If abnormal input data is input, the output data reconstructed by the autoencoder has errors for the input data.

The autoencoder model is pre-trained using a trajectory history matrix representing the normal trajectory of the target as training data. The method of training the autoencoder model may comprise an encoder neural network and a decoder neural network. The trajectory history matrix may refer to a data structure that represents the normal trajectory or path of the target over time. The trajectory history matrix may store historical information about the target's movement, such as its positions, velocities, or other relevant variables across different time steps. The autoencoder model may be pre-trained using the trajectory history matrix as its training data for teaching the autoencoder model about typical trajectories. The trajectory history matrix may be structured in a way that may easily be processed by a neural network, such as a sequence of coordinates or states that represent the target's past movements. The autoencoder model would then learn patterns from this data, which may later be used for tasks like anomaly detection, trajectory prediction, or reconstruction of incomplete trajectory data.

The processor 120 receives trajectory history data samples from the memory 110. In the present disclosure, the trajectory history data sample, which is part of the trajectory history data, refers to trajectory information of the target sampled for a certain period of time.

In the present disclosure, a sampling refers to acquiring trajectory information of a target from a specific point in the past to the present time from trajectory history data. In the sampling, a time window of a sampling may be adjusted to improve the performance of the trajectory prediction accuracy evaluation method. In other words, the time window of a sampling may be lengthened or shortened considering the performance of the sensor, the accuracy of the values measured by the sensor, and past driving history.

In an example, time window of a sampling may be set to be different depending on a driving environment. For example, time window of a sampling may be set to be different in highway driving situations and downtown driving situations. To reflect the uncertainty of the subject vehicle depending on driving situations, the time window of a sampling may be set to be slightly long (e.g., 5 seconds) in the case of driving on a highway. In the case of downtown driving, the time window of a sampling may be set to be slightly short (e.g., 2 seconds).

In addition to highway and downtown driving, the time window of a sampling could be set differently depending on various driving environments. For instance, in rural driving, where there are fewer obstacles and changes, the time window of a sampling might be longer, such as 6 seconds, to account for more stable conditions. In heavy traffic, where frequent stopping and starting occurs, the time window of a sampling may be shorter, like 1 second, to quickly capture changes in vehicle behavior. These adjustments may ensure the vehicle adapts to various environments effectively.

The processor 120 generates a trajectory history matrix of the target using trajectory history data samples. If there are n pieces of trajectory information of the target included in the trajectory history data sample and each trajectory information includes m measurement values, the trajectory history matrix is an m×n matrix. Each column of the trajectory history matrix represents trajectory information at a specific time point.

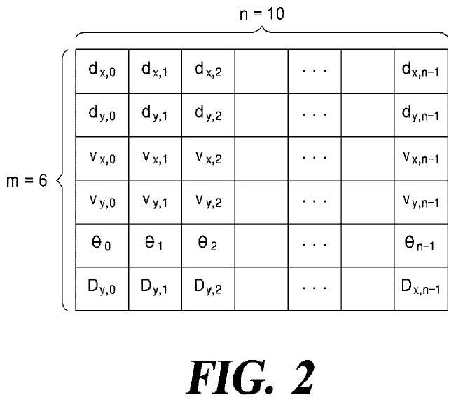

FIG. 2 shows an example of a trajectory history matrix generated by the processor 120 according to an example of the present disclosure. If time window of a sampling is set to 3 seconds, the processor 120 receives trajectory history data from a previous time point (t=−3) to a current time point (t=0). Each trajectory information includes 6 measurement values including a longitudinal relative distance dx, a lateral relative distance d_{y}, a longitudinal relative speed vₓ, a lateral relative speed v_{y}, and a heading angle θ between the subject vehicle and the target at a specific time point, a heading angle θ, and a lateral relative distance D_{y} between the target and a lane. Therefore, if there are 10 pieces of trajectory information of the target included in the trajectory history data sample, the trajectory history matrix is a 6×10 matrix. A first column of the trajectory history matrix represents trajectory information of the target at the current time (t=0), and an n-th column represents trajectory information measured 3 seconds ago.

The analyzer 124 inputs the trajectory history matrix to the pre-trained AI model 122. If the trajectory history matrix is input to the AI model that has completed learning, the AI model outputs a reconstructed trajectory history matrix.

The analyzer 124 may determine reconstruction loss using the input (trajectory history matrix) and output (reconstructed trajectory history matrix). Reconstruction loss refers to a difference between input and output. The analyzer 124 calculates the difference between the input data and the output data, and if the difference is greater than or equal to a specific value, the analyzer 124 may determine that the data is abnormal data.

The reconstruction loss may refer to the error or difference between the original input (the trajectory history matrix) and the output generated by the autoencoder (the reconstructed trajectory history matrix). The autoencoder may be trained to compress the input data into a smaller representation (encoding) and then reconstruct it back to the original form (decoding). However, the output (reconstructed trajectory history matrix) may rarely be a perfect copy of the input, and the reconstruction loss quantifies the extent of this difference. The loss may be determined using various mathematical measures, such as the Mean Squared Error (MSE) or another distance metric, depending on the implementation. If the reconstruction loss (difference between input and output) is small, it may be concluded that the input data is “normal” because the autoencoder was able to accurately reconstruct the trajectory history. If the reconstruction loss exceeds a certain threshold (greater than or equal to a specific value), it may be concluded that this as an indication that the input data is abnormal (e.g., not fit the patterns the model has learned from normal trajectory data). This mechanism may be used for anomaly detection, where the autoencoder is trained on typical (normal) data, and large reconstruction losses signal unusual or abnormal data that doesn't conform to the learned patterns.

In another example of the present disclosure, the analyzer 124 may determine a rank of the trajectory history matrix. The rank of the matrix refers to the number of linearly independent columns in the matrix.

The rank of the trajectory history matrix may be a measure of the trajectory history matrix's ability to represent different vectors in a vector space. In other words, the number of linearly independent columns in the trajectory history matrix may represent how many unique patterns or directions of movement the trajectory history matrix may describe without redundancy. Each linearly independent column may contain information that may not be recreated by a combination of other columns, meaning it adds distinct information about the trajectory. This may give insight into the complexity or diversity of the movement data represented in the trajectory history matrix.

The method of determining the rank of a trajectory history matrix may comprise the following steps:

### Matrix Reduction (Row Echelon Form or Reduced Row Echelon Form)

An approach to determine the rank is to reduce the trajectory history matrix to row echelon form (REF) or reduced row echelon form (RREF) using Gaussian elimination or Gauss-Jordan elimination. This may involve performing row operations (such as row swaps, scaling rows, and adding/subtracting rows) to simplify the trajectory history matrix. In the row echelon form, the trajectory history matrix is transformed such that all non-zero rows are above rows of all zeros, and the leading entry (pivot) of each non-zero row is to the right of the leading entry of the row above it.

### Counting the Non-Zero Rows (or Pivots)

Once the trajectory history matrix is in row echelon form, the rank is equal to the number of non-zero rows (or equivalently, the number of pivot columns). Since each non-zero row corresponds to a linearly independent vector, this may give the number of linearly independent columns or rows in the matrix.

Alternatively, another method for determining rank may involve computing the singular value decomposition (SVD) of the trajectory history matrix, where the rank is the number of non-zero singular values. The rank may also be found by examining the determinants of submatrices. Specifically, the largest square submatrix with a non-zero determinant gives the rank of the trajectory history matrix. This rank determination may help determine how much of the information in the trajectory history matrix is linearly independent, which may be useful in analyzing the complexity or variability of the trajectory data.

The evaluator 126 may receive the reconstruction loss of the trajectory history matrix from the analyzer 124. The evaluator 126 may receive the rank of the trajectory history matrix from the analyzer 124. The evaluator 126 may receive a target recognition confidence level at the current time point from the sensor of the autonomous vehicle.

The evaluator 126 may evaluate accuracy of trajectory prediction of the target using at least one of the rank of the trajectory history matrix, reconstruction loss, or the target recognition confidence level. The evaluator 126 may evaluate the accuracy of trajectory prediction by calculating an accuracy metric. Equation 1 is an equation for calculating the accuracy of trajectory prediction according to an example of the present disclosure.

$$A = \sum {{ω}_{i} ( {X}_{i} )}^{*} \qquad [ Equation 1 ]$$

In Equation 1, Xᵢ refers to a variable used to evaluate accuracy of trajectory prediction. (Xᵢ)* denotes a normalized value of the variable Xᵢ. wᵢ is a weight for the variable Xᵢ and indicates the extent to which the variable Xᵢ is reflected in the evaluation of accuracy of trajectory prediction. wᵢ may be set to be different depending on an autonomous driving scenario and/or operating conditions of the autonomous driving system.

Equation 2 is an equation for calculating accuracy of trajectory prediction of the target based on the rank of the trajectory history matrix, reconstruction loss, and target recognition confidence level according to an example of the present disclosure.

$$A = {{ω}_{1} ( R )}^{*} + {{ω}_{2} ( L )}^{*} + {{ω}_{3} ( C )}^{*} \qquad [ Equation 2 ]$$

In Equation 2, R is the rank of the trajectory history matrix, Lis the reconstruction loss, and C is the target recognition confidence level. w₁ is the weight of R, w₂ is the weight of L, and w₃ is the weight of C. By a linear combination of w₁, w₂, and w₃, the extent to which R, L, and C are reflected in the evaluation of accuracy of trajectory prediction may be determined. In an example of the present disclosure, w₁, w₂, and w₃ may be values turned to be pre-determined according to the autonomous driving scenario and/or operating conditions of the autonomous driving system. Therefore, the values of w₁, w₂, and w₃ may vary depending on the autonomous driving scenario and/or operating conditions of the autonomous driving system.

Accuracy of trajectory prediction may indicate uncertainty about a future state of the target. For example, if the target is a vehicle and the driver tends to drive aggressively, it is unlikely that the driver will drive on a consistent route. Therefore, the accuracy of trajectory prediction is low. Conversely, a vehicle that is stopped for a certain period of time is likely to remain stopped at a certain point in the future. Therefore, the accuracy of trajectory prediction is high. As another example, when the target is a pedestrian, if a distribution of the speed and direction of the pedestrian collected for a certain period of time in the past is large, there is a high possibility that a future trajectory will be inconsistent. Therefore, the accuracy of trajectory prediction is low. Conversely, if a pedestrian moves at a constant speed and direction, the future trajectory is also highly likely to be maintained. Therefore, the accuracy of trajectory prediction is high.

If the target moves irregularly, there is a high possibility that measured values included in the trajectory information of a target will be irregular. In order to reflect the uncertainty of the target, it is assumed that as the rank of the trajectory history matrix increases, the target moves irregularly. Therefore, in an example according to the present disclosure, the weight w₁ has a value of 0 or less (w₁≤0).

If the target moves irregularly, reconstruction loss of the trajectory history matrix is likely to be large. In order to reflect the uncertainty of the target, it is assumed that as the reconstruction loss of the trajectory history matrix increases, the target moves irregularly. Therefore, in an example according to the present disclosure, the weight w₂ has a value of 0 or less (w₂≤0).

As the target recognition confidence level of the sensor increases, the accuracy of trajectory prediction of the target increases. Therefore, in an example according to the present disclosure, the weight w₃ has a value of 0 or more (w₃≥0).

Various normalization methods for each variable, such as min-max normalization and Gaussian normalization, may be applied.

As an example, Equation 3 is an equation of performing min-max normalization on each variable. In Equation 3, X denotes the variable on which normalization is to be performed, and (X)* denotes a normalized variable.

$${( X )}^{*} = \frac{X}{Max - Min} \times 100 \qquad [ Equation 3 ]$$

In an example of the present disclosure, when applying min-max normalization to the rank of the trajectory history matrix, which is an m×n matrix, Max is a smaller value among m and n and Min is 0 in Equation 3.

In an example of the present disclosure, when applying min-maxi normalization to the reconstruction loss, Max is a maximum value of the reconstruction loss output during a training process of the autoencoder and Min is a minimum value of the reconstruction loss output during the training process of the autoencoder in Equation 3.

In an example of the present disclosure, when applying min-max normalization to the recognition confidence level of the sensor, Max and Min in Equation 3 are determined according to confidence level signal output specifications of the sensor. Max is a maximum confidence level output of the sensor, and Min is a minimum confidence level output of the sensor.

The evaluator 126 determines that the predicted trajectory of the target is valid if the accuracy of trajectory prediction is greater than or equal to a pre-determined value. If the accuracy of trajectory prediction is less than the pre-determined value, the evaluator 126 determines that the predicted trajectory of the target is invalid.

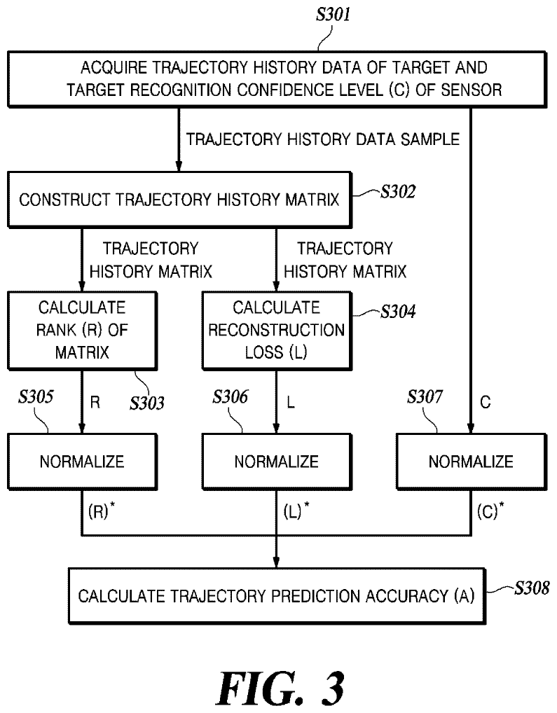

FIG. 3 shows an example of a trajectory prediction accuracy evaluation method according to an example of the present disclosure.

The accuracy evaluation device receives the trajectory history data and the target recognition confidence level C of the sensor from the sensor and stores the same in the memory 110 (S301).

The processor 120 receives a trajectory history data sample from the memory 110. The processor 120 constructs a trajectory history matrix based on the trajectory history data sample (S302).

The processor 120 calculates the rank R of the trajectory history matrix (S303). The processor 120 inputs the trajectory history matrix into the pre-trained AI model 122. The AI model 122 outputs a reconstructed trajectory history matrix. The processor 120 calculates the reconstruction loss L based on the trajectory history matrix and the reconstructed trajectory history matrix (S304).

The processor 120 normalizes the rank R, the reconstruction loss L, and the target recognition confidence level C of the trajectory history matrix (S305 to S307). The processor 120 calculates a trajectory prediction accuracy value A based on the rank R of the normalized trajectory history matrix, the reconstruction loss L, and the target recognition confidence level C (S308).

The present disclosure provides a method and system for determining the accuracy of target trajectory prediction by analyzing uncertainty about a future state of the target based on the trajectory history of the target.

Technical objects to be achieved by the present disclosure are not limited to those described above, and other technical objects not mentioned above may also be clearly understood from the descriptions given below by those skilled in the art to which the present disclosure belongs.

According to an example of the present disclosure, there is an effect of improving the performance of determining the accuracy of trajectory prediction by considering even the uncertainty in the target movement based on trajectory history data of the target, as well as the target recognition confidence level of sensor at the current time point.

According to an example of the present disclosure, there is an effect of efficiently extracting the specificity of input information by calculating reconstruction loss using an autoencoder.

According to an example of the present disclosure, there is an effect of enabling more accurate trajectory planning and collision avoidance control of an autonomous vehicle based on improved technology of determining the accuracy of trajectory prediction.

The advantageous effects of the present disclosure are not limited to those described above; other advantageous effects of the present disclosure not mentioned above may be understood clearly by those skilled in the art from the descriptions given below.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various examples of systems and techniques described herein can be realized with digital electronic circuits, integrated circuits, field programmable gate arrays (FPGAs), application specific integrated circuits (ASICs), computer hardware, firmware, software, and/or combinations thereof. The various examples can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are shown in the flowcharts/timing charts in this specification as being sequentially performed, this is merely an exemplary description of the technical idea of one example of the present disclosure. In other words, those skilled in the art to which one example of the present disclosure belongs may appreciate that various modifications and changes can be made without departing from essential features of an example of the present disclosure, that is, the sequence shown in the flowcharts/timing charts can be changed and one or more operations of the operations can be performed in parallel. Thus, flowcharts/timing charts are not limited to the temporal order.

Although examples of the present disclosure have been described for exemplary purposes, those skilled in the art will appreciate that various modifications, additions, and substitutions are possible, without departing from the idea and scope of the claimed feature. Therefore, examples of the present disclosure have been described for the sake of brevity and clarity. The scope of the technical idea of the present examples is not limited by the figures. Accordingly, one of ordinary skill would understand that the scope of the claimed feature is not to be limited by the above explicitly described examples but by the claims and equivalents thereof.

What is claimed is:

1. An apparatus for controlling autonomous driving of a vehicle, the apparatus comprising:
a processor; and
a memory configured to store one or more instructions, when executed by the processor, configured to cause the apparatus to:
store trajectory history data of a target object;
generate, based on the trajectory history data, a trajectory history matrix for a time window of a sampling;
input the trajectory history matrix into a machine learning model to determine reconstruction loss, wherein the machine learning model comprises an autoencoder trained based on previous trajectory history data associated with movement of at least one object;
determine, based on the reconstruction loss, a trajectory prediction accuracy;
generate a signal indicating the trajectory prediction accuracy; and
control, based on the signal, the autonomous driving of the vehicle.

2. The apparatus of claim 1, wherein the one or more instructions, when executed by the processor, further configured to cause the apparatus to determine a rank of the trajectory history matrix, wherein the determination of the trajectory prediction accuracy is further based on the rank of the trajectory history matrix.

3. The apparatus of claim 2, wherein the rank of the trajectory history matrix corresponds to a number of linearly independent columns in the trajectory history matrix.

4. The apparatus of claim 1, wherein the determination of the trajectory prediction accuracy is further based on a target recognition confidence level of a sensor.

5. The apparatus of claim 4, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

6. The apparatus of claim 1, wherein the one or more instructions, when executed by the processor, are further configured to cause the apparatus to set, based on a driving environment of the vehicle, the time window of a sampling to a different time window.

7. The apparatus of claim 1, wherein the one or more instructions, when executed by the processor, are further configured to cause the apparatus to set the time window of a sampling to be longer for a highway driving than a downtown driving.

8. A method performed by an apparatus for controlling autonomous driving of a vehicle, the method comprising:
storing trajectory history data of a target object;
generating, based on the trajectory history data, a trajectory history matrix for a time window of a sampling;
inputting the trajectory history matrix into a machine learning model to determine reconstruction loss, wherein the machine learning model comprises an autoencoder trained based on previous trajectory history data associated with movement of at least one object;
determining, based on the reconstruction loss, a trajectory prediction accuracy;
generating a signal indicating the trajectory prediction accuracy; and
controlling, based on the signal, the autonomous driving of the vehicle.

9. The method of claim 8, further comprising:
determining a rank of the trajectory history matrix, wherein the determining the trajectory prediction accuracy is further based on the rank of the trajectory history matrix.

10. The method of claim 9, wherein the rank of the trajectory history matrix corresponds to a number of linearly independent columns in the trajectory history matrix.

11. The method of claim 8, wherein the determining the trajectory prediction accuracy is further based on a target recognition confidence level of a sensor.

12. The method of claim 11, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

13. The method of claim 8, further comprising:
setting, based on a driving environment of the vehicle, the time window of a sampling to a different time window.

14. The method of claim 8, further comprising:
setting the time window of a sampling to be longer for a highway driving than a downtown driving.

15. A non-transitory computer-readable medium storing instructions, when executed, cause an apparatus to:
store trajectory history data of a target object;
generate, based on the trajectory history data, a trajectory history matrix for a time window of a sampling;
input the trajectory history matrix into a machine learning model to determine reconstruction loss, wherein the machine learning model comprises an autoencoder trained based on previous trajectory history data associated with movement of at least one object;
determine, based on the reconstruction loss, a trajectory prediction accuracy;
generate a signal indicating the trajectory prediction accuracy; and
control, based on the signal, autonomous driving of a vehicle.

16. The non-transitory computer-readable medium of claim 15, wherein the instructions, when executed, are further configured to cause the apparatus to determine a rank of the trajectory history matrix, wherein the determination of the trajectory prediction accuracy is further based on the rank of the trajectory history matrix.

17. The non-transitory computer-readable medium of claim 16, wherein the rank of the trajectory history matrix corresponds to a number of linearly independent columns in the trajectory history matrix.

18. The non-transitory computer-readable medium of claim 15, wherein the determination of the trajectory prediction accuracy is further based on a target recognition confidence level of a sensor.

19. The non-transitory computer-readable medium of claim 18, wherein the reconstruction loss represents a difference between the trajectory history matrix inputted to the machine learning model and second trajectory history matrix outputted by the trained autoencoder, and wherein the target recognition confidence level indicates a degree of confidence that the sensor has correctly identified an object.

20. The non-transitory computer-readable medium of claim 15, wherein the instructions, when executed, are further configured to cause the apparatus to set, based on a driving environment of the vehicle, the time window of a sampling to a different time window.
